(19) United States
(12) Patent Application Publication
(10) Pub. No.: US 2012/0307356 A1
(43) Pub. Date: Dec. 6, 2012

(54) Technique for Telescope Polar Alignment

(76) Inventors: Ning Xu, Nanjing (CN); Wen Xu, Nanjing (CN)

(21) Appl. No.: 13/153,434

(22) Filed: Jun. 5, 2011

(51) Int. Cl. G02B 23/16; G02B 23/00

(52) U.S. Cl. 359/428; 359/430

(57) ABSTRACT

A polar scope for a telescope mount includes a reticle having a pattern with multiple markings that allows users to accurately position pole stars for precise polar alignment. A system and mount may be provided including a polar scope of this kind. The polar scope may be provided with a controller that calculates the apparent position of a pole star, while accounting for errors, such as proper motion, precession of the earth's axis, and/or atmospheric refraction.

### CROSS-REFERENCES TO RELATED APPLICATIONS

Not Applicable.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO A “SEQUENCE LISTING,” A TABLE, OR A COMPUTER PROGRAM LISTING APPENDIX

Not Applicable.

### BACKGROUND OF THE INVENTION

1. Field of the Invention

This invention relates generally to astronomical telescopes, and, more particularly, to polar alignment of astronomical telescope mounts.

2. Description of Related Art

Astronomical telescopes are essential observing equipment for professional and amateur astronomers alike. Telescopes are available in a wide variety of optical types, including refracting, reflecting, and catadioptric systems, and with a wide variety of mounts, including altazimuth, equatorial, and spherical mounts.

Both altazimuth and equatorial mounts allow telescopes to rotate about two perpendicular axes. In a typical altazimuth mount, the axes allow up-down rotation of the telescope (altitude) and left-right rotation (azimuth). In an equatorially mounted telescope, the two axes are angled based on the observer's latitude, such that one axis allows rotation in declination (celestial “longitude”) and the other axis allows rotation in right ascension (celestial “latitude”). Equatorial mounts offer the advantage of single-axis tracking. With the mount aligned to a celestial pole (north or south), the mount can be counter-rotated in right ascension only to compensate for the earth's rotation. Equatorial mounts are generally equipped with clock drive units on their right ascension axes, which automatically provide the requisite counter-rotation to track celestial objects.

The benefits of equatorial mounts can be enjoyed, however, only when the mounts are properly aligned. Polar alignment is generally achieved by orienting the telescope mount so that its right ascension axis points directly at a celestial pole. For observers in the Northern Hemisphere, this entails orienting the telescope so that its right ascension axis points in the approximate direction of Polaris, also known as alpha Ursae minoris, or the “North Star.” For observers in the Southern Hemisphere, polar alignment entails orienting the telescope so that its right ascension axis points in the approximate direction of Polaris Australis, also known as sigma Octantis.

FIG. 1 shows an example of an equatorial mount 100 for carrying a telescope. This type of mount is known in the art as a German equatorial mount. The mount 100 includes a declination axis 110 and a right ascension axis 112. Internal shafts and bearings allow rotation of the mount 100 about both the declination and right ascension axes. A telescope tube assembly (not shown) may attach to a clamp 120. The mount 100 may also include a counterweight shaft 122 and adjustable counterweight 124, for balancing the weight of the tube assembly. The mount includes an adjustment wedge 114. The wedge has a base 116, which is rotatably coupled to a tripod 118. Typically, the mount 100 may include motor assemblies 126 and 128 for effecting controlled rotation of the mount in declination and right ascension, respectively. The mount 100 may also include a communications interface 130, for communicating with a controller for receiving commands to control the motors 126 and 128.

The wedge 114 is adjustable in altitude (up-down position) as well as in azimuth (left-right position). Rough polar alignment can be achieved by adjusting the altitude of the wedge 114 to match the observer's latitude and by rotating the wedge 114 on its base 116 with respect to the tripod 118 so that the right ascension axis points north (or south, in the Southern Hemisphere).

More precise polar alignment can be conducted with the use of a polar scope. As is known, a “polar scope” is a small telescope of generally fixed magnification, which is provided specifically for the purpose of polar aligning a larger telescope. In German equatorial mounts like the mount 100, a polar scope may be provided within the mount concentric with the right ascension axis. The polar scope may include cross hairs or another type of reticle to allow accurate alignment, and the mount is manufactured to ensure that the optical axis of the polar scope closely matches the right ascension axis.

To protect the polar scope, the mount 100 may include an end cap 134 and an ocular cover 132. The internal declination shaft (not shown) may include a transverse hole through which light may pass when the mount is oriented at a particular declination angle, thereby allowing a clear line of sight for the polar scope.

As is known, neither Polaris nor sigma Octantis is located at the precise north or south celestial pole, respectively. Therefore, accurate polar alignment, as may be required for long exposure astrophotography, generally involves adjusting the mount 100 so that the pole star is slightly offset from the polar scope's center.

Various approaches have been devised to orient a mount to properly place the pole star. One approach involves providing a polar scope with a reticle having a circle etched upon it. When an observer looks through the polar scope, the observer sees the circle superimposed on background stars. The circle is sized so that its radius corresponds to the declination offset of the pole star from the true pole (e.g., 41.5 arc minutes for Polaris). The user then adjusts the mount to place the pole star on the circle at the correct angle. The angle is determined by the star's coordinates, location of the telescope, and time of day. When the pole star lies on the circle at the correct angle, the mount is properly aligned. Another approach employs a low power polar scope with a reticle having a pattern of multiple stars etched upon it. The reticle may be rotated within the polar scope. The observer adjusts the mount and rotates the reticle so that the stars seen through the polar scope line up with the pattern of stars projected from the reticle. When the actual star images intersect with the star images from the reticle, the mount is polar aligned.

### BRIEF SUMMARY OF THE INVENTION

The inventors hereof have recognized and appreciated that both of these techniques rely on the assumption that the positions of polar alignment stars are fixed. This assumption is inaccurate for at least two reasons. First, the celestial coordinates of pole stars, such as Polaris and sigma Octantis, do indeed move over the course of an observer's lifetime. This movement is due in part to proper motion of the stars (i.e., their own movement through the galaxy) but primarily to precession of the earth's axis. Second, the apparent position of a polar alignment star is affected by the atmosphere. Atmospheric refraction can alter the apparent position of polar alignment stars, causing poor alignment to occur even when star positions as viewed through the polar scope appear to be correct.

The inventors hereof have developed a novel technique for promoting more accurate polar alignment. The technique involves providing a polar scope having a reticle that includes multiple inscribed declination circles spaced apart from one another by at most 10 arc-minute intervals. The multiple circles allow users to accurately judge angular distance across the reticle and therefore accurately place the polar alignment object, whose apparent position may vary, relative to the circles on the reticle. In one aspect, a controller is provided to indicate the position of the polar alignment object. The indicated position includes corrections for any of proper motion, precession, or atmospheric refraction of the polar alignment object.

### BRIEF DESCRIPTION OF THE SEVERAL VIEWS OF THE DRAWINGS

FIG. 1 shows an example of an equatorial mount that may be equipped with a polar scope according to an embodiment of the invention;

FIG. 2 shows an example of a polar scope in accordance with an illustrative embodiment of the invention;

FIG. 3 shows an example of a pattern used on a reticle of the polar scope of FIG. 2;

FIG. 4 shows an example of a controller that may be used to control the equatorial mount of FIG. 1

FIG. 5 shows an example of an image displayed by the controller of FIG. 4 to indicate polar alignment criteria;

FIG. 6 shows a view through the polar scope of FIG. 2, including the reticle pattern of FIG. 3 superimposed on a background star, such as Polaris; and

FIG. 7 shows an example of a process whereby the controller of FIG. 4 may produce polar alignment criteria.

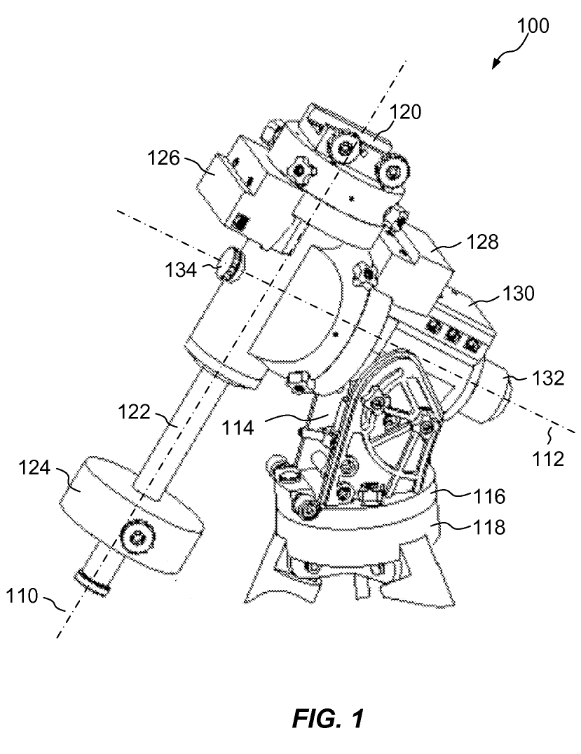

### DETAILED DESCRIPTION OF THE INVENTION

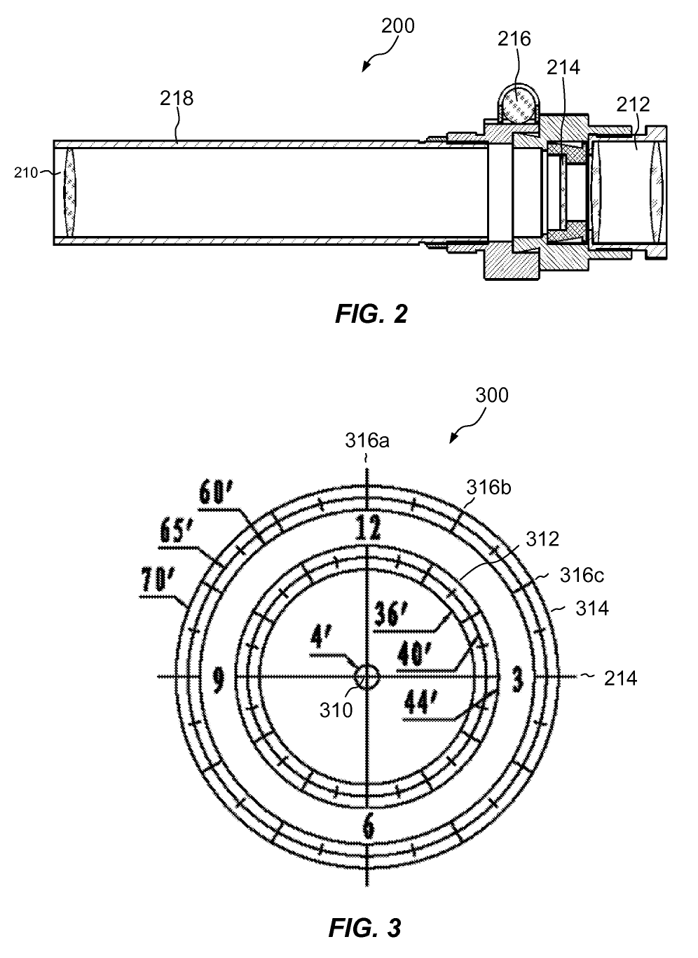

FIG. 2 shows an example of a polar scope 200, which may be provided in accordance with embodiments of the invention. The polar scope 200 may include an objective lens 210, an ocular 212, and a reticle 214. These may be axially aligned and held in place within a tube 218. In one example, the polar scope 200 may be provided as part of the equatorial mount 100 concentric with the right ascension axis 112 of the mount. In another example, the polar scope 200 may be attached to the mount parallel to the right ascension axis but not concentric therewith.

The objective lens 210 may be a single element lens or a compound lens, such as an achromatic or apochromatic lens. The objective lens 210 has a focal length representing the distance from the objective at which focused images of distant objects may be produced.

The reticle 214 is preferably positioned at a distance from the objective lens 210 that equals the objective's focal length. The reticle 214 may have the shape of a circular disc and may be composed of a transparent material, such as glass, plastic, quartz, or the like. A pattern may be provided on or within the reticle 214. The pattern may be formed in any number of ways, such as by etching or printing on a surface of the reticle. The pattern may have a preferred orientation, i.e., it may include markings that are designed to be oriented vertically or horizontally when the polar scope is in use.

The ocular 212 may be placed at an end of the tube 218 opposite the objective 210. It may be threadedly or otherwise variably attached to the tube, to allow the ocular to be advanced or refracted to accommodate the focusing needs of different users of the polar scope. In the example shown, the ocular 212 includes two lens elements. However, this is merely an example. Different numbers of lens elements may be provided, based on desired optical characteristics and cost.

When a user looks through the ocular 212 in the direction of the objective lens 210, the user may see focused images of distant objects, such as stars, superimposed on a focused image of the pattern of the reticle. The user may adjust the mount to position particular stars at designated places within the field of view of the polar scope and relative to the pattern of the reticle.

Optionally, the polar scope 200 may include a bubble level 216 and a reticle illumination control (not shown). The bubble level 216 may be aligned with the reticle 214 so that the bubble level indicates level when the reticle pattern is properly oriented. The illumination control may be provided as a knob that allows a user to manually adjust the brightness of the reticle pattern as seen through the polar scope. Alternatively, the illumination control may be operated using other means, such as via buttons on a hand-held controller used with the telescope mount.

FIG. 3 shows an example of a pattern 300 of the reticle 214. A user of the polar scope 200 would typically see an image of the pattern 300 when looking through the polar scope.

The pattern 300 has a number of distinct features. These may include a center 310 and groups of circles 312 and 314. The circles in the group 312 may include, for example, three circles each being concentric with the center 310. A greater or lesser number of circles may be provided in the group 312. The circles in the group 314 may also include, for example, three circles, each concentric with the center 310. A greater or lesser number of circles may be provided in the group 314.

The polar scope 200 is designed such that each circle in the groups 312 and 314 identifies a specific angle of celestial declination when the scope is polar aligned. In one example, the first group 312 may include at least two circles marking declination angles between 30 and 50 arc-minutes relative to the center. The second group may include at least two circles marking declination angles between 55 and 75 arc minutes relative to the center. The numbers used to indicate declination are preferably given as offsets from the celestial pole, which has a declination angle of 90 degrees (or −90 degrees in the Southern Hemisphere). Expressing the angles as offsets avoids the need to include on the pattern 300 the full declination coordinates, which include both degrees and minutes.

In the example shown, the circles in the group 312 mark declination offsets of 36 minutes, 40 minutes, and 44 minutes, and the circles in the group 314 mark offsets of 60 minutes, 65 minutes, and 70 minutes. These particular markings are convenient “round” numbers; however, they may be varied as desired. The first group 312 is positioned to provide circles that correspond to the approximate declination vicinity of Polaris. The second group 314 is positioned to provide circles that correspond to the approximate declination vicinity of sigma Octantis. It is envisioned, therefore, that the circles 312 will be used primarily in the Northern Hemisphere, and the circles 314 will be used primarily in the Southern Hemisphere.

The provision of multiple circles for each of the groups 312 and 314 eases the task of aligning a pole star with respect to the pattern 300. For example, the declination of Polaris may vary over an observer's lifetime or as a result of atmospheric refraction. Providing more than one circle allows users to accurately place the pole star between circles or outside circles. It is simply easier for users to judge angular distance relative to the pattern 300 when multiple circles are provided in each group.

The pattern 300 may include a number of line segments radially aligned with the center 310. In one example, the line segments are arranged to correspond to hours of a clock. They may include, for example, one or more line segments designating each hour, such as 1 o'clock, 2 o'clock, 3 o'clock, and so forth. Additional line segments may be provided to subdivide each “hour” into smaller increments. In one example, there are at least 24 line segments equally spaced. The different line segments may therefore mark different intervals of right ascension when the polar scope is aligned.

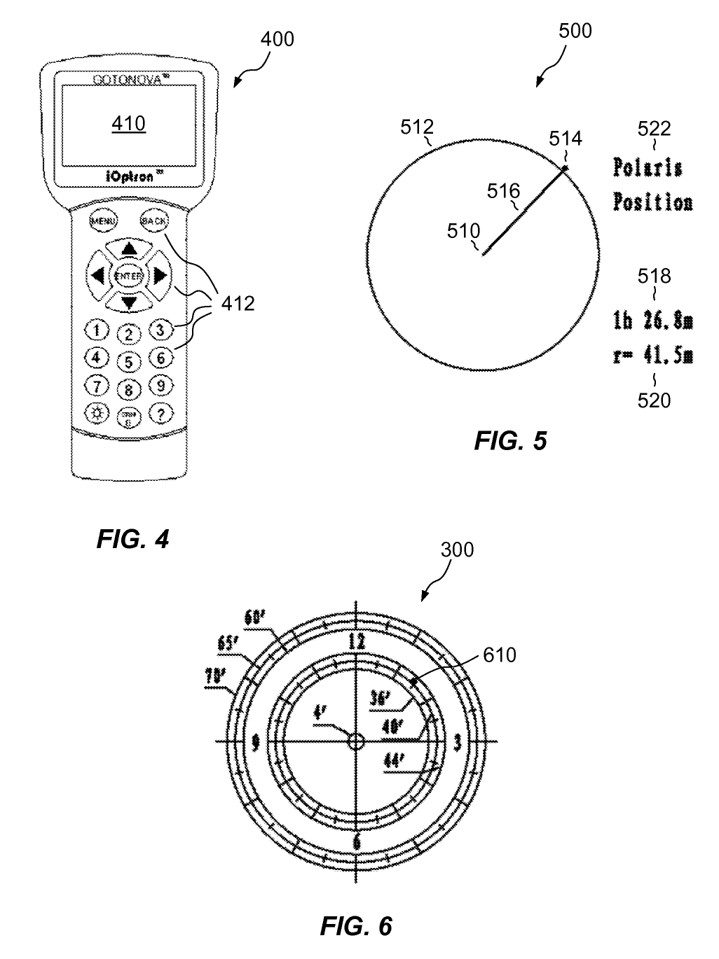

FIG. 4 shows a hand-held controller 400, which may be used in connection with the equatorial mount 100 and polar scope 200. The controller 400 includes a display 410 and buttons 412. It may also include a processor and a memory (not shown). The controller 400 may be connected to the communications interface 130 of the mount using one or more cables. In one example, the controller may be a GotoNova® controller, available from iOptron Corporation in Woburn, Mass.; however, this is not required. Other types of controllers may be used.

The controller 400 may be programmed to output to its display 410 an indication of the current position of a polar alignment object, such as Polaris or sigma Octantis. This may occur, for example, when the controller is first powered on.

FIG. 5 shows an example of an indication produced by the controller 400 on the display 410 for indicating the desired position of a polar alignment object. The indication may include numerical information and/or a graphical image. The numerical information may include a right ascension coordinate 518 and a declination coordinate 520 of the polar alignment object. An identification of the object, e.g., “Polaris Position” 522, may also be indicated. The graphical image may include a circle 512 having a center 510, and a line segment 516 extending from the center 510 to a graphical representation 514 of the polar alignment object. With the information displayed, the user may proceed to polar align the mount.

FIG. 6 depicts an image of what a user may see when looking through the polar scope 200 during polar alignment. The user may need to rotate the mount 100 in right ascension so that the 12 o'clock indication on the reticle pattern 300 points directly up. Use of the bubble level 216 may facilitate this task. The user may then typically adjust the mount 100 in altitude and/or azimuth to place the designated pole star at the location indicated in the display 410. In the example shown, the user may place Polaris (the dot 610) at the designated location, i.e., at 1 h 26.8 m right ascension offset and 41.5 m declination offset. Doing so will align the mount to the pole.

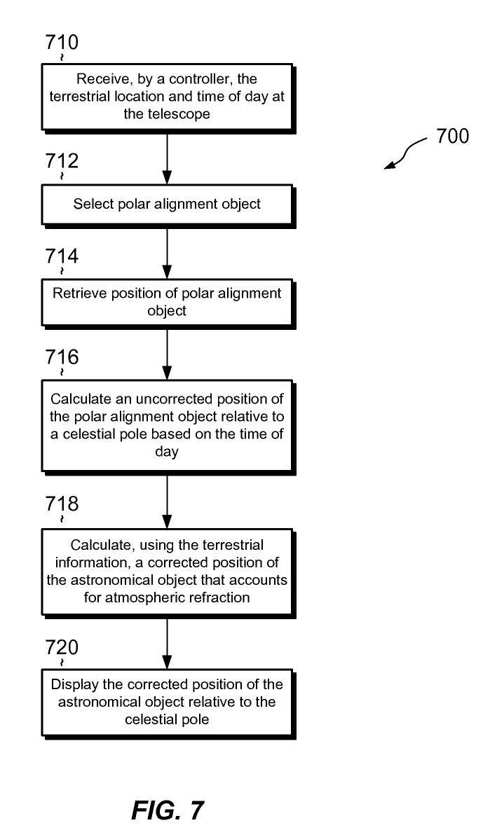

FIG. 7 shows a process 700 for producing accurate polar alignment information, such as that shown in FIG. 5. The process 700 is preferably performed in connection with software or firmware instructions running on the controller 400. The instructions may be stored, read into the memory, and executed by the processor. Output from the processor may be provided to the display 410.

At step 710, the controller may receive a terrestrial location of the telescope and a time of day. The terrestrial location may take any number of forms, such as GPS (Global Positioning Satellite) coordinates, terrestrial latitude and longitude manually inputted by a user, or simply a place name, such as “Boston,” inputted by the user, which place name has previously been associated with a certain geographic location. The time of day may be received in any number of forms, such as time manually inputted by the user, time read from GPS or other satellites, time read from a radio source, or over the Internet (if the controller 400 is connected to the Internet).

At step 712, the controller 400 may select a suitable polar alignment object. The controller 400 may first check the terrestrial location. If the location is in the Northern Hemisphere, the controller may select Polaris. If the location is in the Southern Hemisphere, the controller may select sigma Octantis. If the location is near the equator, the controller may use additional information, such as the date, to determine the optimal pole star, or it may prompt the user to input the preferred pole star.

At step 714, the controller 400 may retrieve the position of the selected polar alignment object. This position may correspond to the right ascension and declination coordinates of the selected pole star. For example, the position of Polaris at time of this writing is approximately 2 h 32 min right ascension and +89 deg 16 min declination.

At step 716, the controller 400 may calculate an uncorrected position of the selected pole star relative to the telescope mount. The uncorrected position may simply be the coordinates of the pole star re-referenced to the polar scope's location and time. In one example, the uncorrected position may be in a form similar to that shown in FIG. 5.

At step 718, the controller may calculate a corrected position of the selected pole star. The corrected position may correct for various errors, including proper motion of the pole star, precession of the earth's axis, and/or atmospheric refraction.

To correct for proper motion and precession, step 718 may involve looking up the position of the pole star in a table stored in the controller that indicates changes in the position of the pole star as a function of time, or calculating the position of the pole star based on one or more equations programmed into the controller that account for its apparent motion. Once a corrected position accounting for proper motion and/or precession is determined, the controller 400 may store the updated position in the controller for later use, thereby avoiding the need to determine the corrected position each time the telescope is used. Positions may be determined again annually or on some other regular schedule.

The controller 400 may also correct for atmospheric refraction. As is known, atmospheric refraction is zero at the zenith but increases rapidly as the horizon is approached. To correct for refraction, the controller may first determine the altitude of the pole star, i.e., its angular elevation above the horizon. Altitude may be determined by the coordinates of the pole star, the geographic location of the telescope, and the time of day. The altitude of the pole star is higher near the poles and lower near the equator. It also varies slightly based on time of day, as the pole star makes its apparent journey around its respective celestial pole. By applying latitude and time of day, the controller 400 may accurately calculate the true altitude of the pole star. It may then calculate an apparent altitude (where the star appears to the observer) based on the following equation:

$$R = 1.02 cot ( h + \frac{10.3}{5 + 5.11} ) ,$$

where “R” is the refraction in arc-minutes and “h” is the true altitude in degrees.

As is known, atmospheric refraction varies with temperature and pressure. The above equation assumes an atmospheric pressure of 101.0 kPa and a temperature of 10° C. For different pressure P and temperature T, refraction calculated from the formula above may be adjusted as follows:

$${R}^{′} = R \frac{P}{110} \frac{283}{273 + T} ,$$

where P is the pressure in kPa and T is the temperature in degrees centigrade in the vicinity of the telescope.

In one example, the controller 400 may be provided with the local temperature and/or pressure in the vicinity of the telescope. For instance, the controller 400 may include an on-board thermometer and/or barometer. Alternatively, the controller may accept temperature and/or pressure manually entered by the user, or it may obtain one or both through radio or other wireless signals or Internet connections to remote (but not necessarily distant) sources of local temperature and/or pressure. More sophisticated implementations may account for differing temperature and pressure at various layers of the atmosphere along the line-of-sight of the telescope, and/or may account for atmospheric humidity.

Refraction has the effect of displacing objects upwards in altitude. Therefore, the value of R (or R′) should be added to the true altitude computed above to determine the apparent (observed) altitude of a pole star.

The resulting position of the pole star may then be provided in the form of corrected coordinates relative to the polar scope. These may be output to the user via the display 410 in a manner similar to that shown in FIG. 5 (step 720). The user may then align the mount to the designated coordinates to accurately account for atmospheric refraction and/or other errors.

Although steps of the process 700 are shown and described in a particular sequence, the sequence is merely exemplary. Except where clear dependencies are present, the sequence of steps may be varied from that shown, and/or certain steps may be performed simultaneously. Terms indicating sequence, such as “first,” “second,” “next,” “then,” and so forth, are merely conventions used to facilitate description and do not limit the order in which steps may be performed.

In addition, it is not strictly required that there be separate steps of computing an uncorrected position and computing a corrected position of the polar alignment object. Alternatively, these steps may be condensed into a single step where there is no intermediate uncorrected position. For example, the controller may obtain the coordinates of the pole star, apply known transformations to convert them into local altitude and azimuth coordinates, adjust the altitude based on the computed refraction, and then convert the corrected altitude and azimuth back to coordinates referenced to the pole. These coordinates may then be output to the display 410, to provide the corrected position of the pole star to the user.

Having described certain embodiments, numerous alternative embodiments or variations can be made. For example, although the polar scope is shown and described in connection with the hand-held controller 400, this is merely an example. Alternatively, the controller may be another type of computing device, such as a laptop computer, desktop computer, PDA, smart phone, tablet computer, or the like. In one example, the controller may be a smart phone running an application (app) for controlling a telescope mount. The mount may be controlled via a Bluetooth or other wireless connection between the smart phone and the communications interface 130. The method 700 may be conducted using software and/or firmware on the smart phone. The smart phone may have access information relative to the process (e.g., GPS information, temperature and pressure, etc.) using the smart phone's existing communication capabilities.

Although the polar scope has been described in connection with a German equatorial mount, it may also be used with other types of telescope mounts. Nonlimiting examples may include fork mounts, yoke mounts, horseshoe mounts, cross-axis mounts, and altazimuth mounts provided with equatorial platforms.

Also, although the reticle pattern 300 is shown having a first group of circles around 40′ and a second group of circles around 65′, this is merely an example. Alternatively, the reticle pattern may have one group of circles but not the other. For instance, the reticle pattern 300 may have only the first group for use in the Northern Hemisphere, or only the second group for use in the Southern Hemisphere. It may have other groups of circles around different polar alignment objects. In addition, each group of circles may have a greater or lesser number of circles than the three circles shown.

As used throughout this document, the words “comprising,” “including,” and “having” are intended to set forth certain items, steps, elements, or aspects of something in an open-ended fashion. Although certain embodiments are disclosed herein, it is understood that these are provided by way of example only and the invention is not limited to any particular embodiment or embodiments disclosed.

Unless clearly indicated otherwise, the phrase “at least one of A and B” means one or more of A or one or more of B. Unless clearly indicated, “at least one of A and B” does not mean at least one of A and at least one of B.

Various aspects of the present invention may be used alone, in combination, or in a variety of arrangements not specifically set forth in the foregoing. For example, aspects described in one embodiment may be combined in any manner with aspects described in other embodiments. Also, the various methods or processes outlined herein may be encoded as software. The software may be written using any of a number of suitable programming languages and/or programming or scripting tools.

Also, the invention or portions thereof may be embodied as a computer-readable storage medium, such as a magnetic disk, magnetic tape, compact disk, DVD, optical disk, flash memory, Application Specific Integrated Circuit (ASIC), Field Programmable Gate Array (FPGA), and the like. Multiple computer-readable media may be used. The medium (or media) may be encoded with instructions which, when executed on one or more computers or other processors, perform methods that implement the various embodiments of the invention described above. Such medium (or media) may be considered an article of manufacture or a machine, and may be transportable from one machine to another.

Those skilled in the art will therefore understand that various changes in form and detail may be made to the embodiments disclosed herein without departing from the scope of the invention.

What is claimed is:

1. A polar scope, comprising:
an objective;
an ocular; and
a reticle positioned between the objective and the ocular, the reticle having a pattern visible through the ocular, the pattern including—
a center,
a plurality of line segments oriented radially with the center, and
a plurality of circles concentric with the center, the plurality of circles marking known intervals of declination referenced to objects viewed through the polar scope and including at least two circles spaced apart by a declination interval no greater than 10 arc minutes.

2. The polar scope as recited in claim 1, wherein said at least two circles mark declination angles between 30 and 50 arc-minutes relative to the center.

3. The polar scope as recited in claim 1, wherein said at least two circles mark declination angles between 55 and 75 arc-minutes relative to the center.

4. The polar scope as recited in claim 2, wherein said at least two circles is a first group of circles, and the plurality of circles further comprises a second group of circles including at least two circles that mark declination angles between 55 and 75 arc-minutes relative to the center.

5. The polar scope as recited in claim 4, wherein said first group of circles comprise three circles and said second group of circles comprise 3 circles.

6. The polar scope as recited in claim 1, wherein the plurality of line segments comprises at least twenty-four equally spaced line segments.

7. A polar alignment system for a telescope, comprising:
a polar scope, the polar scope including—
an objective;
an ocular; and
a reticle positioned between the objective and the ocular, the reticle having a pattern visible through the ocular, the pattern including—
a center,
a plurality of line segments oriented radially with the center,
a plurality of circles concentric with the center, the plurality of circles marking known intervals of declination referenced to objects viewed through the polar scope and including at least two circles spaced apart by a declination interval no greater than 10 arc minutes, and
at least one marking indicating a declination angle of at least one of the plurality of circles;
and;
a controller having a processor, a memory, and a display, wherein the processor is constructed and arranged to—
(i) retrieve, from the memory, the celestial position of a polar alignment object;
(ii) calculate a corrected position of the polar alignment object relative to the telescope, the corrected position accounting for atmospheric refraction, and
(iii) output, to the display, an indication of the corrected position of the polar alignment object, said indication being in the same units as the at least one marking on the reticle.

8. The system as recited in claim 7, wherein the processor is further constructed and arranged to—
determine an elevation above the horizon of the uncorrected position of the polar alignment object; and
compute a refraction error based at least in part on said elevation.

9. The system as recited in claim 8, wherein the processor is further constructed and arranged to compute the refraction error based in part on at least one of local air temperature or pressure.

10. The system as recited in claim 9, wherein the controller is constructed and arranged to receive, from a different location, signals indicative of at least one of local air temperature and pressure.

11. A telescope mount, comprising:
a declination axis;
a right ascension axis orthogonal to the declination axis; and
a polar scope parallel to the right ascension axis, the polar scope having an objective, an ocular, and a reticle positioned between the objective and the ocular, the reticle having a pattern visible through the ocular, the pattern including a center, a plurality of line segments oriented radially with the center, and a plurality of circles concentric with the center, the plurality of circles marking known intervals of declination referenced to objects viewed through the polar scope and including at least two circles spaced apart by a declination interval no greater than 10 arc minutes.

12. The telescope mount as recited in claim 11, wherein the plurality of line segments comprises at least twenty-four equally spaced line segments.

13. The polar scope as recited in claim 11, wherein said at least two circles mark declination angles between 30 and 50 arc-minutes relative to the center.

14. The polar scope as recited in claim 11, wherein said at least two circles mark declination angles between 55 and 75 arc-minutes relative to the center.

15. The polar scope as recited in claim 13, wherein said at least two circles is a first group of circles, and the plurality of circles further comprises a second group of circles including at least two circles that mark declination angles between 55 and 75 arc-minutes relative to the center.

16. The polar scope as recited in claim 15, wherein said first group of circles comprise three circles and said second group of circles comprise 3 circles.

17. The telescope mount as recited in claim 11, further comprising a controller having a processor and a display, the processor constructed and arranged to compute a position of a polar alignment object and output the computed position to the display.

18. The telescope mount as recited in claim 17, wherein the position of the polar alignment object is a corrected position that accounts for at least one of (i) estimated errors in an apparent position of the polar alignment object caused by atmospheric refraction, (ii) precession of the earth's axis, and (iii) proper motion of the polar alignment object.

19. The telescope mount as recited in claim 17, wherein the position of the polar alignment object output to the display is provided as a graphical image comprising:
at least one circle having a center and a radius corresponding to a predetermined declination angle; and
a graphical depiction of the polar alignment object showing its corrected current position relative to the at least one circle.

20. The telescope mount as recited in claim 19, wherein the graphical image further comprises a line extending from the center to the graphical depiction of the polar alignment object.
